(19) United States
(12) Patent Application Publication
(10) Pub. No.: US 2007/0055744 A1
(43) Pub. Date: Mar. 8, 2007

(54) Multimedia distribution system

(75) Inventors: Rich Gasper, Phoenix, AZ (US); Gianfranco Fiorio, Arlington, VA (US)

Correspondence Address: BRAD CLOSE;TIGHE PATTON, PLLC, 1747 PENN. AVE. NW, SUITE 300, WASHINGTON, DC, 20006-4604, US

(73) Assignee: Alpha Omega International

(21) Appl. No.: 11/479,670

(22) Filed: Jun. 30, 2006

Related U.S. Application Data
(60) Provisional application No. 60/709,545, filed on Aug. 19, 2005.

(51) Int. Cl. G06F 15/16

(52) U.S. Cl. 709/217; 709/201

(57) ABSTRACT

A multimedia distribution system that comprises a digital carrier with a unique identifier thereon (4), a performance in digital media (2) and de-compression software (8). The unique identifier is encoded in at least one of the de-compression software (10) and the digital medium and the performance is copied to the digital carrier (3). The digital carrier transfers the performance to a machine along with the de-compression software (9). The de-compression software attempts to verify the unique identifier on the digital carrier (12), and if the de-compression software verifies the unique identifier, the performance is played on the machine (14).

### BACKGROUND

Distribution of pre-recorded multimedia has suffered from drawbacks such as portability, durability, illegal copying and efficient distribution. For example, DVD players are bulky and not portable. DVDs and CDs are relatively large and are easily damaged. The DVDs and CDs can also be easily copied, costing the industry billions of dollars a year.

What is needed is a multimedia distribution system that overcomes some or all of these problems. Other difficulties with the prior art also exist, some of which will be apparent upon further reading.

### SUMMARY OF THE INVENTION

The present invention provides for a multimedia distribution system that can be portable, durable and resistant to copying. A multimedia performance, such as a movie, song, video, show, video game, etc. is stored in digital format. This digital format is cryptically compressed and stored onto a digital carrier, such as a disk, card, stick, etc. Also de-compression software may be stored on the digital carrier that is capable of de-compressing the cryptically compressed multimedia performance (compressed data). The de-compression software can also be part-and-parceled with playing software that is capable of playing the multimedia performance on a given machine.

The cryptically compressed multimedia performance is practically only able to be de-compressed by specific de-compression software. The de-compression software may be stored on the digital carrier distinctly from the cryptically compressed multimedia performance, or the two may be inexorably linked together. The present invention prevents unauthorized playback of performance, but in addition to this industry standard anti-copying techniques may be present as well.

If the compressed data and de-compression software have been inexorably linked, then only the one performance, or specific replacement performance, may be played off of the digital carrier that contains the inexorably linked decompression software. If not inexorably linked, then the performance may be changed on the specific digital carrier or specific set of digital carriers. This change may be done over computer networks such as the Internet, or by other methods that would be apparent to one of ordinary skill in the art.

The de-compression software is further capable of reading an identifier, such as a serial number, on the digital carrier. The identifier on the digital carrier may be unique or part of a batch, and is essentially burned onto the digital carrier such that it may not be altered or hidden. The de-compression software will only de-compress the cryptically compressed multimedia performance if it recognizes the serial number as an approved serial number, thereby protecting the performance from copying. The de-compression software recognizes the unique identifier by comparing it to a encoded unique identifier that is either added to the decompression software itself or to the performance in digital media. In some embodiments, multiple unique identifiers are used and/or the encoded unique identifiers are placed in multiple locations within the performance or decompression software.

The decompression software may also be further capable of reading other identifiers that will allow (or conversely prohibit) decompression. These include the size of the cryptically compressed data, hidden codes in the compressed data, times and dates (actual), times and dates when a performance was put in digital medium, and the number of times decompression has previously run.

Other embodiments of the present invention also exist, which will be apparent upon further reading of the detailed description.

### BRIEF DESCRIPTION OF THE FIGURES

FIG. 1 illustrates a flow chart that summarizes one embodiment of the present invention for distributing and playing performances.

FIG. 2 illustrates what a user may do after obtaining a performance of the present invention.

FIG. 3 illustrates a specific embodiment of the present invention as used with a PDA.

### DETAILED DESCRIPTION OF THE INVENTION

The present invention provides for a multimedia distribution system that can be portable, durable and resistant to copying. A multimedia performance, such as a movie, song, video, show etc. is stored in digital format. This digital format is cryptically compressed to produce a cryptically compressed multimedia performance, also referred to herein as compressed data. The compressed data is then stored onto a digital carrier. Digital carriers are portable, data storage devices, such as a disk, card, stick, thumb drive, chip, CD, and other comparable devices known in the art. The digital carrier may be writeable for some embodiments discussed below, although it does not have to be writeable for all embodiments discussed.

In some embodiments, the de-compression software is also stored on the digital carrier. This is particularly true when the coded unique identifier is placed into the de-compression software, as discussed below. If the de-compression software is not provided on the digital carrier, then the de-compression software will have to be separately installed on a machine. The de-compression software is capable of de-compressing the cryptically compressed multimedia performance. The cryptical compression refers to a secret or unobvious way of compression, such that one of ordinary skill in the art would not be able to de-compress the compressed data without the provided de-compression software. For example, in order to decipher a compression, someone would have to know the compression structure being used down to the level of developed header values that represent compression schemes, and how other compression choices are made.

The de-compressor can also be also part-and-parceled with playing software that is capable of playing the multimedia performance on a given machine. For some platforms the part-and-parceling is required, for example, with a Palm™. This also represents another point of control, since certain performances may be licensed only for certain media. For example, say movie X is stored on a data chip according to the present invention, and the decompression software de-compresses the compressed data into a generally playable format. Presumably, any machine capable of using the data chip can then play the movie. However, if the format is specific for personal digital assistants (PDAs) then it can only run on PDAs and licensing or control issues may be provided for in this manner.

As discussed, in one embodiment the de-compression software is integral with the playing software, such that the de-compressed data will not run on any other player. This prevents copying of the performance as it is being de-compressed. If a player and decompressor are kept separate, then it is easier to intercept the data as it is moved from the decompressor to the player. By integrating them tighter, the data will only play on the linked player. In other embodiments the de-compression software may be run with separate players. If the players are separate, then they should contain provisions to prevent the content from being copied, such as digital rights management bits.

It is also possible to have multiple players. For example, one linked to the data, one linked to the decompressor, and one independently on a platform such as a computer.

The de-compression software is further capable of reading an identifier, such as a serial number, on the digital carrier. The identifier on the digital carrier may be unique or part of a batch, and is essentially burned onto the digital carrier such that it may not be altered or hidden. Even if the identifier is unique, there should be a portion of the identifier that is common to a group or sub-group of digital carriers. For example, all chips that are to carry approved movies may have a “9999” prefix. Chips that are approved to carry movie X may have a “9999-11” prefix. This is only an example, and the different ways of categorizing batch identifiers are numerous. These identifiers are typically installed by the digital carrier manufacture, but may also be installed after manufacture depending on the digital carrier used, for example, the name of the performance, the category, the owner, etc.

The de-compression software will only de-compress the cryptically compressed multimedia performance if it recognizes the identifier as an approved identifier and verifies the check-sum, thereby protecting the performance from copying. In the example given above, if the chip does not have the “9999-11” prefix it will not play movie X. So copying the movie will not benefit a copier unless they copy it to another chip with the “9999-11” prefix. It is thereby important that the identifier on the digital carrier be controlled. The digital carrier may also have an external, printed-on identifier that is distinct from the digital identifier discussed.

The de-compression software recognizes the unique identifier by comparing it to the encoded unique identifier that has been encoded into the de-compression software and/or the performance that is in digital media. An advantage of encoding the unique identifier exclusively in the performance is that once the contents of a particular digital carrier has been loaded into a machine, changing the digital carrier (and therefore the performance) would not require that the machine re-install or update the de-compression software and even the player. Otherwise it would behoove the system to try and anticipate all of the potential changes in numbers that might be used.

It is also contemplated that multiple encoded unique identifiers will be used in some embodiments. This pertains to both multiple different encoded unique identifiers as well as multiple copies of the same unique identifier encoded in various locations through out both the de-compression software and the performance. In the latter instance, the multiple copies of the unique identifier can be placed many times and at random points, to further hide detection. The multiple copies can, for example, be set to specific sub-routines in the de-compressor and integrated player, or they can be set to correspond to segments within the digital performance. For example, to stop someone from removing a chip in mid performance, a subroutine can independently re-verify the unique identifier at intervals. Therefore, even if a hacker were able to properly embed or switch a unique identifier within a pirated movie, they might only get minutes or seconds worth of footage.

Chips on the market have a single unique identifier, although it can be scores of digits in length. Typically, this unique identifier is broken down into sub segments for multiple uses. However, an additional tool will be to have multiple unique identifiers on a single chip. This will allow for a variety of additional security. For example, multiple unique identifiers can be embedded in a performance, so that the finding and processing of any single unique identifier still will not allow a performance to be played. Further, the additional unique identifiers can be hidden, so that only programs with specific instructions will be able to find them, therefore adding yet another layer of security.

Although other embodiments of using multiple different unique identifiers are discussed, one embodiment is the facilitation of various levels of playback for the same performance. For example, say a performance is encoded with three types of unique identifiers, each with multiple copies spread throughout the data. When the performance is copied to a certain batch of digital carrier with a certain serial number batch, only a preview will be shown. When copied to another certain batch with a different serial number batch, a full performance will be shown. And when copied to a third batch, an extended performance will be shown. If copied to a batch with no matching batch serial numbers, then a warning, ad or some other message will be shown.

The unique identifier refers to serial numbers or similar identifier burned into a digital carrier. Currently chips, referred to as secured digital chips are the most widely spread digital carrier that use serial numbers as unique identifiers. Suppliers of these secure digital chips include Sandisc™ PNY™ and Sony™.

In some embodiments, however, the unique identifier may be a combination of other data on the digital carrier, which may be combined with the unique serial number identifier discussed above. Therefore, the decompression software may also be further capable of reading other identifiers that will allow (or conversely prohibit) decompression. This other information may be a date of creation, current date and time, other hidden codes, number of times decompression has run, file size and other factors. Using a file size as an element of a unique identifier allows, for example, a monitor on tapering. If expected and actual file size do not match then tampering is evident.

The cryptically compressed multimedia performance is practically only able to be de-compressed by the specific de-compression software. The de-compression software may be stored on the digital carrier distinctly from the cryptically compressed multimedia performance, or the two may be inexorably linked together. The present invention prevents unauthorized playback of the performance, but in addition to this standard industry anti-copying techniques may be present as well.

If the compressed data and de-compression software have been inexorably linked, then only the one performance may be played off of the digital carrier, or specific replacement performances. In other words, any de-compression software on or transferred to the digital carrier has to be able to recognize its identifier; thus the performance is locked to the chip. However, if not inexorably linked, then the performance may be changed on the specific digital carrier or specific set of digital carriers. The de-compression software and player can also be made to function only on given machines, which would then mean, in this example, that if the performance has changed, a user could still not change the specific media that has shown the performance.

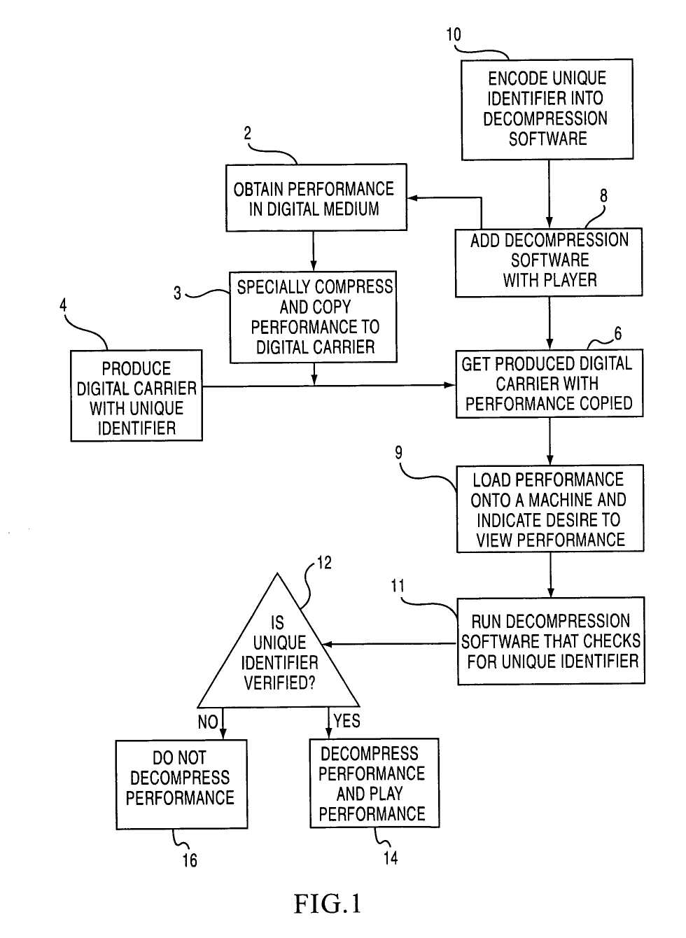

Referring to FIG. 1, a flow chart illustrating one embodiment of the present invention is shown. A performance needs to be transcribed into digital format 2, which is then specially compressed using a cryptic compression method 3. The cryptic compression is not readily de-compressed and requires specially decompression software. Digital carriers are produced 4 that have embed thereon unique identifiers that cannot be altered or faked. The unique identifiers may be truly unique to each individual carrier, but more often they contain a unique batch number that is unique to that batch. This may be an exclusive identifier or it may be part of a larger identifier and system including factors such as date, size, number of times accessed, etc. Compression technology is known in the art, but some providers include Alpha Omega™ Inc, Microsoft™, and Real™

The compressed performance is copied to the digital carrier 3 to get a digital carrier with the performance copied thereon 6. Special decompression software 8 is also added to the digital carrier, although it may be added as an integral component to the performance or separately depending on the application. The decompression software also contains a player 8 that is capable of playing the performance on a given media machine. The unique identifier has been encoded into the decompression software and/or the digital performance 10, which may include both many different unique identifiers and many copies of each. The decompression software is not readily reverse engineered, nor is the encoded unique identifier readily able to be changed. Multiple unique identifiers may also be encoded into the decompression software so that it may recognize any one of a number of unique identifiers as explained below.

The produced digital carrier is then loaded onto a machine 9 and a desire to view the performance is indicated. This desire may be the physical placing of the digital carrier into the machine itself. Or it may be the selection of an icon or play button or other mechanism as will be apparent to one of ordinary skill in the art.

The decompression software is then at least in part run, and it checks for the unique identifier 11, 12. If the unique identifier is verified the performance is decompressed and played 14, and may also be re-verified periodically. A feature of the player software is that it does not allow the performance to be copied while playing, short of actually filming the video screen where it is being played or similar pirating technique. If the unique identifier is not verified then the performance is not decompressed 16. Additional actions may be taken if the decompression software does not verify the unique identifier, such as displaying warnings, sending alerts, notifying authorities, running malicious software, and other actions.

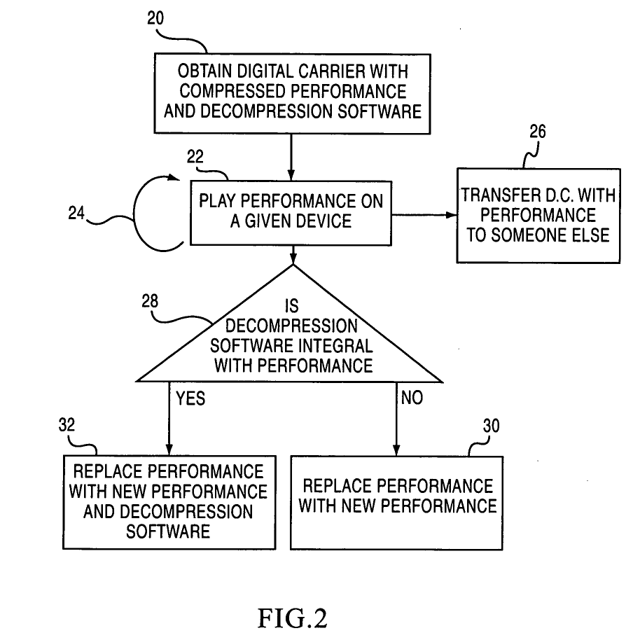

Referring to FIG. 2, an embodiment of the present invention is diagrammed on a macro-scale. A user first obtains a digital carrier with compressed performance and decompression software 20. This is then played on a given device 22. The device itself may offer a form of control, since programs are often tailored to specific devices. The user may then watch the performance repeatedly 24, although limits may be built into the decompression software such as number of times run or dates. Once the user is done with the performance there are a variety of steps that may be taken. The digital carrier may be transferred to someone else 26. This someone else may be an acquaintance, but it may also be a retailer that exchanges performance based upon some business model.

If the performance and decompression software are not linked, then the performance may be replaced with a new performance 28, 30. This is not automatic, however since other anti-copying technology may be in place to prevent this. A more particular approach is that the performance and decompression software are linked 28, 32. This requires the whole replacement or updating of the performance with the decompression software. The new decompression software will then read the digital carrier's unique identifier and play or not play the movie accordingly. This latter embodiment allows for classes of performance to be distributed. For example, a particular batch unique identifier(s) may be authorized for any playing of a movie in a horror class. All horror movie performances are coupled to decompression software that recognizes a specific unique identifier, or group of specific unique identifiers. As long as every new decompression software that is loaded onto the digital carrier recognizes/verifies the unique identifier, then the performance may be played. In this manner a user may purchase a digital carrier that is good for any number of horror movies. Note that is just one example, and different categories may be readily apparent, such as other genres (e.g. action or romance), performance types (movies or music videos), rating categories (e.g. family only), price categories (premium movies vs. standard movies), etc.

When all or part of a unique identifier is being encoded into a performance, it may be done on a predetermined basis, which will be useful for batch processing. However, it may also be done on a case by case basis, which is more useful for individual applications. A unique identifier on a specific chip can be read, and then incorporated into a performance that is placed on the very same chip. Records of these types of transaction can be kept so that accounts can be billed, commissions can be paid (eg every store that sells specific chips gets a percentage of every performance download to them), and other database management.

A particular model is a store with a physical location that gets customers who have unique chips (either previously owned or bought at that store). Customers use computers, which may be in the form of kiosks, at the store to select and download performances to the chip. For every performance download at the store, the store may retain a certain commission. The user may then use a store chip to download more performances over the Internet, and the store where the chip was purchased can receive a commission on that download as well. The chips can either be pre-associated with certain stores (eg a particular string of digits in the unique identifier is store specific) or when the chip is used at a certain store a database associates that chip with that store.

Icons can also be put on the chips to readily indicate what performances are stored thereon. These icons may also have images or clips from the performance to further aid in identification.

As mentioned above, a number of unique identifiers may be encoded onto a given digital carrier. In addition, multiple performances may be encoded as well. The decompression software may be duplicated for each performance, or a single version of the decompression software may be present for each digital carrier.

A specific example of the present invention is given in respect to movie theater houses. A particular problem with movie theaters is that the hard copies of the distrusted movies may be copied. By use of the present invention, any copies of the digital carrier will be unplayable.

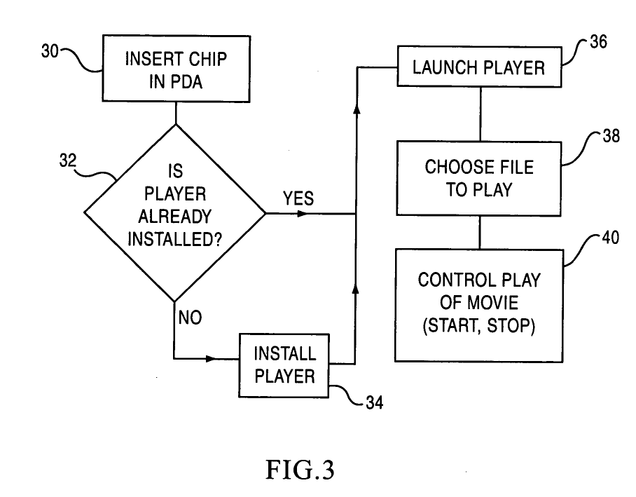

Another specific example is using the present invention with portable machines, such as lap-tops, notebooks and PDAs. A user, for example in an airport, can buy a chip with a movie, and watch it on their flight directly on their portable machine. At the next airport, they can exchange the chip for a different movie, or even have a new movie copied onto the same chip, assuming that the new movie gets approved for the serial number batch of that chip. Or, the user can download a new movie to that chip himself. A macroscopic scale of this is illustrated in FIG. 3. A digital carrier, in this case a chip, is inserted into a PDA 30. If the player is already installed then the player is launched 32, 36; if not, then the player is installed 34 and then launched 36. The user might have an option on what performance file to play 38, which is then played. Typical controls, such as start and stop for movie commands 40 can be available to the user.

In one embodiment the present invention provides for a multimedia distribution system, that comprises a digital carrier with at least one unique identifier thereon, a performance in digital medium, and decompression software. The performance is cryptically compressed, the unique identifier is encoded in at least one of the de-compression software and the digital medium, and the performance is copied to the digital carrier. Then the de-compression software attempts to verify the unique identifier on the digital carrier, and if it does so the performance is decompressed and played on a machine. In some cases the attempts to verify require that the unique identifier in at least one of the compression software and the performance matches at least a minimum number of digits in the unique identifier on the digital carrier.

As discussed, the unique identifier may be unique to the particular chip, or to a batch of chips. A user may have some editable control over the unique identifier so that they can add further unique digits to the digital carrier.

In a particular embodiment the digital carrier is a secure digital chip. The unique identifier is encoded in at least one of the compression software and the performance a plurality of times. The unique identifier in one of the compression software and/or the performance is in random locations. The de-compression software can be copied to the digital carrier. The player can also be integrated with the de-compression software. Multiple performances can be copied to the digital carrier.

In other particular embodiments, a plurality of unique identifiers are used. Different unique identifiers control different levels of playback of the performance. In some cases at least two unique identifiers are used. The de-compression software is part of a player.

In another embodiment the present invention provides for a multimedia distribution system that comprises cryptically compressing a performance in digital media to produce a cryptically compressed performance, copying the cryptically compressed performance onto a digital carrier, where the digital carrier has at least one unique identifier. Then running a decompression program on the cryptically compressed performance that is capable of decompressing the cryptically compressed performance. The decompression program reads the unique identifiers on the digital carrier and compares it to at least one embedded unique identifier in at least one of the decompression program and the cryptically compressed performance. The decompression program determines if the embedded unique identifier is sufficiently similar to the unique identifier, and if so it decompresses the performance which allows for playing of the performance.

In some embodiments the decompression software and the cryptically compressed performance are inexorably linked. In other embodiments the embedded unique identifier is in multiple locations in the performance. If so, the embedded unique identifier can comprise at least two separate identifiers, and the similarity of either to the unique identifier is sufficient to decompress the cryptically compressed performance. Or the embedded unique identifier can comprise at least two separate identifiers, and the similarity of both to at least one unique identifier is sufficient to decompress the cryptically compressed performance. Also a different version of the performance can be played depending on the type of the unique identifier on the digital carrier.

In other embodiments the decompression software further verifies accuracy of at least one of date, time, number of times played, platform, and password, prior to decompression the cryptically compressed performance. The decompression software may decompress for playing at least a portion of the performance prior to determining the embedded unique identifier is sufficiently similar to the unique identifier on the digital carrier.

In still another embodiment the present invention provides for a movie distribution system that comprises cryptically compressing a movie to make a cryptically compressed movie, and embedding at least one movie identifier into the cryptically compressed movie in at least one location, placing the cryptically compressed movie onto a computer system that is capable of synchronizing with the digital carrier. The digital carrier has at least one digital identifier thereon, linking the computer system to the digital carrier and transferring the cryptically compressed movie to the digital carrier, running decompression software on the cryptically compressed movie. The decompression software compares the movie identifier with the digital identifier of a minimal level of similarity, and if the minimal level of similarity is found, then the decompression software decompresses the movie for playing on a machine. In some cases the distribution of the movie is recorded into a database. Also the movie identifier may be derived from the computer system reading the digital identifier on the digital carrier prior to the completion of the cryptically compressed of the movie. In some cases, particular for online downloading, the machine is the same device as the computer system.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which is to be given the full breadth of the claims appended and any and all equivalents thereof.

What is claimed is:

1. A multimedia distribution system, comprising:
a digital carrier with at least one unique identifier thereon;
a performance in digital medium; and
decompression software;
wherein said performance is cryptically compressed;
wherein said unique identifier is encoded in at least one of said de-compression software and said digital medium;
wherein said performance in copied to said digital carrier;
wherein said de-compression software attempts to verify said unique identifier on said digital carrier;
wherein if said de-compression software verifies said unique identifier, said performance is decompressed and played on a machine;
wherein the attempts to verify require that said unique identifier in the at least one of said compression software and said performance matches at least a minimum number of digits in said unique identifier on said digital carrier.

2. The distribution system of claim 1, wherein said unique identifier is encoded in at least one of said compression software and said performance a plurality of times.

3. The distribution system of claim 2, wherein said unique identifier in at least one of said compression software and said performance is in random locations.

4. The distribution system of claim 1, wherein said de-compression software is copied to said digital carrier.

5. The distribution system of claim 1, wherein said player is integrated with said de-compression software.

6. The distribution system of claim 1, wherein multiple performances are copied to said digital carrier.

7. The distribution system of claim 1, wherein a plurality of unique identifiers are used.

8. The distribution system of claim 7, wherein different unique identifiers control different levels of playback of said performance.

9. The distribution system of claim 1, wherein said de-compression software is part of a player.

10. A multimedia distribution system comprising:
cryptically compressing a performance in digital media to produce a cryptically compressed performance;
copying said cryptically compressed performance onto a digital carrier, wherein said digital carrier has at least one unique identifier; and
running a decompression program on said cryptically compressed performance that is capable of decompressing said cryptically compressed performance;
wherein said decompression program reads the unique identifiers on said digital carrier and compares it to at least one embedded unique identifier in at least one of said decompression program and said cryptically compressed performance;
wherein said decompression program determines if said embedded unique identifier is sufficiently similar to said unique identifier;
wherein said decompression software decompresses said cryptically compressed performance if said embedded unique identifier is sufficiently similar to said unique identifier and allows playing of said performance.

11. The distribution system of claim 10, wherein said embedded unique identifier is in multiple locations in said performance.

12. The distribution system of claim 11, wherein said embedded unique identifier comprises at least two separate identifiers, and the similarity of either to said at least one unique identifier is sufficient to decompress said cryptically compressed performance.

13. The distribution system of claim 11, wherein said embedded unique identifier comprises at least two separate identifiers, and the similarity of both to said at least one unique identifier is sufficient to decompress said cryptically compressed performance.

14. The distribution system of claim 11, wherein a different version of said performance is played depending on the type of said unique identifier on said digital carrier.

15. The distribution system of claim 10, wherein the decompression software further verifies accuracy of at least one of date, time, number of times played, platform, and password, prior to decompression said cryptically compressed performance.

16. The distribution system of claim 10, wherein said decompression software decompresses for playing at least a portion of said performance prior to determining if said embedded unique identifier is sufficiently similar to said unique identifier on said digital carrier.

17. A movie distribution system comprising:
cryptically compressing a movie to make a cryptically compressed movie, and embedding at least one movie identifier into said cryptically compressed movie in at least one location;
placing said cryptically compressed movie onto a computer system that is capable of synchronizing with digital carrier, wherein said digital carrier has at least one digital identifier thereon;
linking said computer system to said digital carrier and transferring said cryptically compressed movie to said digital carrier;
running decompression software on said cryptically compressed movie, wherein said decompression software compares said movie identifier with said digital identifier of a minimal level of similarity, and wherein if said minimal level of similarity is found then said decompression software decompresses said movie for playing on a machine.

18. The movie distribution system of claim 17, wherein the distribution of said movie is recorded into a database.

19. The movie distribution system of claim 17, wherein the movie identifier is derived from said computer system reading said digital identifier on said digital carrier prior to the completion of the cryptically compressed of said movie.

20. The movie distribution system of claim 17, wherein said machine is the same device as said computer system.
